(19) United States
(12) Patent Application Publication
(10) Pub. No.: US 2004/0233067 A1
(43) Pub. Date: Nov. 25, 2004

(54) Acoustic siren detector system

(76) Inventor: Yong Min Cho, Silver Spring, MD (US)

Correspondence Address: Mr. Yong Min Cho, 16605 Sea Island Court, Silver Spring, MD, 20905, US

(21) Appl. No.: 10/441,209

(22) Filed: May 20, 2003

(51) Int. Cl. G08G 1/00

(52) U.S. Cl. 340/901

(57) ABSTRACT

As cars become more soundproof, it also becomes more difficult to hear the sirens of emergency vehicles, especially when music is playing. Many accidents have resulted from this difficulty, as drivers are unable to hear sirens until it is too late to move out of the path of the emergency vehicle so that it can efficiently and quickly move through traffic and reach its destination. By flashing a warning light and beep sound within the drivers' cars, the Acoustic Siren Detector System will allow drivers the advantage of being aware of the presence of an emergency vehicle at a distance where, in a normal situation, the driver would hardly be able to hear the siren. This advance notice will enable drivers to pull to the side of the road, clearing a path for the emergency vehicle. Not only will the Acoustic Siren Detector System reduce the number of accidents resulting from this type of situation, but it will also reduce the amount of time that it takes an emergency vehicle to reach its destination, potentially saving lives. The Acoustic Siren Detector System is advantageous to both emergency personnel and the general public.

### BACKGROUND OF THE INVENTION

The acoustic siren detector system has been designed to visually notify vehicle drivers of the presence of emergency vehicles, such as fire engines and police cars. The acoustic siren detector system will receive the acoustic signals from the outside of the car and detect the high pitch siren sound then generate the visual blinking light and beep sound for the driver. As cars are becoming increasingly more soundproof, it also becomes more difficult to hear incoming sirens early enough to make room for emergency vehicles. Oftentimes, drivers of cars, due to blasting music or closed windows, are unaware of the presence of emergency vehicles until the vehicle actually reaches the car. This situation inhibits the ability of the emergency vehicles to quickly maneuver through traffic and can result in serious accidents. To prevent this situation, the acoustic siren detector system has been designed to visually notify drivers in the path of the emergency vehicle prior to the vehicle's arrival. This will allow cars to make way for the emergency vehicles and will potentially save many lives and avoid any other consequent damages, which may result from a driver not being able to hear the siren.

### SUMMARY OF THE INVENTION

The primary objective of this invention is to provide a visual indication of emergency sirens and beep sound that detect the presence of emergency vehicles through a flashing warning light, thereby allowing car to pull to the side of the road and give the right of way to the incoming emergency vehicles.

### BRIEF DESCRIPTION OF THE DRAWING

This invention can be fully understood through references to the following figure and its brief description below:

FIG. 1 is a conceptual view of the acoustic siren detector system, which is comprised of six parts, an acoustic sensor, an amplifier, a bandpass filter, a siren detector, a light indicator and a beep sound generator.

### DETAILED DESCRIPTION OF THE DRAWING

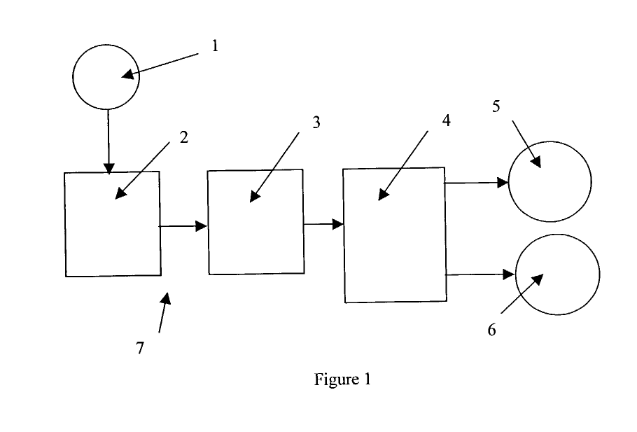

In FIG. 1, the acoustic siren detector system 7 consists of an acoustic sensor 1, an amplifier 2, a bandpass filter 3, a siren detector 4, a light indicator 5 and a beep sound generator 6.

The siren detector 4 will detect the acoustic spectrum generated by a bandpass filter 3 and detect the signal then turn on the blinking warning light of a light indicator 5 and a warning beep sound of a beep sound generator 6, when the emergency vehicles have come within a couple of hundred yards from the acoustic sensor 1.

I claimed:

1. An Acoustic Siren Detector System designed to give visual warning to drivers when emergency vehicles are approaching the car, allowing the drivers to pull off to the side of the road and permitting the emergency vehicles to pass.

2. Any acoustic siren detector of claimed 1.

3. Any acoustic sensor of claimed 1.

4. Any shape and size of the blinking warning light indicator of claimed 1.

5. Any sound of beep sound generator of claimed 1.
